(19) United States
(12) Patent Application Publication
(10) Pub. No.: US 2023/0281387 A1
(43) Pub. Date: Sep. 7, 2023

(54) SYSTEM AND METHOD FOR PROCESSING UNLABELED INTERACTION DATA WITH CONTEXTUAL UNDERSTANDING

(71) Applicant: Genpact Luxembourg S.à r.l. II, Luxembourg (LU)

(72) Inventors: Prakash Selvakumar, Bangalore (IN); Meenakshi Sundaram Murugeshan, Madurai (IN); Payanshi Jain, Jaipur (IN); Gehna Ahuja, Hyderabad (IN); Sai Krishna Reddy, Guntur (IN); Chirag Jain, Bangalore (IN); Sreekanth Menon, Bangalore (IN)

(21) Appl. No.: 17/685,175

(22) Filed: Mar. 2, 2022

(51) Int. Cl. G06F 40/237; G06F 40/279; G06F 40/30; G06N 5/02; G06K 9/62; H04L 51/02

(52) U.S. Cl. CPC G06F 40/237; G06F 40/279; G06F 40/30; G06N 5/022; G06K 9/6227; G06K 9/628; H04L 51/02

(57) ABSTRACT

A method and system for handling unlabeled interaction data with contextual understanding are disclosed. In some embodiments, the method includes receiving the interaction data describing agent-consumer interactions associated with a contact center. The method includes analyzing the interaction data to identify a plurality of features. The method includes automatically performing taxonomy driven classification on the plurality of features to generate a first set of labels associated with the interaction data. The method includes training a deep learning model using the first set of labels and the interaction data to determine a second set of labels. The method then includes intelligently combining the first and second sets of labels to obtain a combined set of labels associated with the interaction data. The method further includes retraining one or more machine learning models using the combined set of labels to enhance contextual understanding of the agent-consumer interactions associated with the contact center.

### TECHNICAL FIELD

This disclosure relates to a method and system for intelligently combining unsupervised and supervised learning approaches with one-time expert review to generate contextual understandings of unlabeled consumer-agent interactions.

### BACKGROUND

Automatic conversational solutions, namely online chatbots, are widely used to perform various tasks or services based on real-time interactions with users/customers. Typically, a chatbot uses a virtual intelligence agent in lieu of a live human agent to provide faster resolution (e.g., to a customer question or to a requested service) and support 24×7 availability in serving customer needs.

Many enterprises have developed chatbots to adapt to their fast-grown business goals, but oftentimes a live human agent (e.g., a customer care representative) may still be needed in place of chatbots. For example, chatbots currently deployed in enterprise settings are narrow and customized to a specific domain. These chatbots are not entirely designed to recognize and understand most of the underlying salient context of a conversation, and therefore cannot generate appropriate responses to address complex user queries and to satisfy user needs. Moreover, although many enterprise chatbots are trained based on supervised learning techniques that map dialogues to responses, there is often a lack of labelled samples and annotated data to train machine learning (ML) models to detect user intents contextually. This may impact model building of the virtual agent and further limit the “intelligence” of the chatbots to provide a pleasant experience for the user. In particular, a volume of user interactions in an enterprise conversation interface may be extremely high. When this volume of data is mainly unlabeled, it becomes a bottleneck to create chatbots and to generate insights for providing quick and useful responses.

### SUMMARY

To address the aforementioned shortcomings, a method and a system for handling unlabeled interaction data with contextual understanding are provided. The method receives the interaction data describing agent-consumer interactions associated with a contact center. For instance, the interaction data may include chat messages, email exchanges, or other types of messages between a consumer/customer and contact center agent. In some embodiments, the interaction data may be received via a conversational interface. The method analyzes the interaction data to identify a plurality of features. The method then automatically performs taxonomy driven classification on the plurality of features to generate a first set of labels associated with the interaction data. These labels represent user intentions specified in the interaction data leveraging contextual understanding. The method further trains a deep learning model using the first set of labels and the interaction data to determine a second set of labels. The method also intelligently combines the first and second sets of labels to obtain a combined set of labels associated with the interaction data. The method further retrains, using the combined set of labels, one or more machine learning models including the deep learning to enhance contextual understanding of the agent-consumer interactions associated with the contact center.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates an exemplary high-level functional view for data processing based on contextual understanding, according to some embodiments.

FIG. 2 illustrates an exemplary high-level technical view for processing unlabeled interaction data with contextual understanding, according to some embodiments.

FIG. 3 is a system for data processing based on contextual understanding, according to some embodiments.

FIG. 4 is a server used as part of a system for data processing based on contextual understanding using the methods described herein, according to some embodiments.

FIG. 5 illustrates an example architecture for processing unlabeled interaction data based on contextual understanding, according to some embodiments.

FIG. 6 is an example interface illustrating contextual understanding of utterances associated with agent-consumer interactions, according to some embodiments.

FIG. 7 illustrates an exemplary general process for identifying and refining contextual labels of interaction data from a conversation interface, according to some embodiments.

FIGS. 8A and 8B illustrate an exemplary specific process for identifying and refining contextual labels of interaction data from a conversation interface, according to some embodiments.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Modern communication channels often support real-time interaction modes (e.g., online chats) to help end-users or customers obtain quick resolution of queries and improve customer experience. For example, a user/customer may interact via a communication channel to inquire about an item, conduct a business transaction, resolve an issue, or get any other help or recommendations that the user seeks for.

A chatbot is a software program that simulates a conversation with a human being, and, in some instances, can use natural language processing techniques and/or models trained using artificial intelligence (AI)/machine learning (ML) techniques. The chatbot is increasingly being leveraged as a first point of contact for contextual understanding and providing appropriate responses to users. Such a chatbot is usually supported by live human agent(s) to handle complex user queries. An automated chatbot with a mere virtual intelligence agent may not be able to provide appropriate responses to complex user queries due to the lack of capability for accurate contextual understanding. For example, the chatbot may use a finite set of rules to drive the response operations of the virtual intelligence agent. The rigid or finite nature of the rules may limit the contextual understanding of the virtual agent and prevent the automated chatbot from efficiently responding to the user queries that exceed the scope of the finite realm of the queries addressable by the chatbot.

Typically, real time analysis (e.g., sentiment analysis, theme mining) can be applied for analyzing interaction data from conversation interfaces. The conversation interfaces may include interfaces providing both automatic responses and human responses. For example, a conversation interface can be a chatbot that supports automatic responses. When a large amount of instant data are generated in a conversation interface, the performance of real time analysis can greatly deteriorate. The volume of interaction data in an enterprise conversation interface, however, can be very high. For example, an established organization can generate data with more than thousands of conversations a day. Further, each conversation can have a variable number of exchanges of messages between customer(s) and the agents. Since context identification and analysis plays a vital role across various insight generation and customer experience improvement, advanced analysis approaches may be developed to utilize the interaction data from conversational interface(s) to enhance customer experience and enterprise value.

To address the above technical problems, the present disclosure provides a solution that reduces workload of conversation agents (e.g., chatbot agents, human agents), and enhances the efficiency of the agents to support complex user queries. This technical solution is particularly advantageous in that (1) it leverages multiple unsupervised learning approaches along with supervised approaches for contextual understanding; (2) it significantly reduces the time-consuming manual efforts in labeling conversational or interaction data; (3) it significantly lessens the dependency on expert review, and thus further reduces the human intervention associated with reviewing unstructured data; and (4) it greatly streamlines and semi-automates the labeled data preparation required for training supervised ML model(s).

A conversation interface solution fundamentally relies on accurately understanding end-to-end context in chat messages. Automatically identifying contexts discussed during chat interactions can greatly benefit insight generation from the messages. The insight generation may include conversation summary generation, agent performance evaluation, enhancements that may be incorporated in conversation interface solutions, or the like. However, the nature of real-time interactions poses significant challenges in automatic context identification. For example, in many conversation interfaces, the interaction messages are ungrammatical and do not contain properly formed sentences. There are other key challenges, for example, customer messages are generally mixed with spelling-errors, slangs, short-forms, and incomplete sentences; customers may mix multiple contexts in the same conversation utterance; customers may not clearly convey the context, etc.

Another critical challenge in developing a reliable context identification mechanism is the scarcity of labeled conversational data for training conversation systems using supervised ML model(s). Although unsupervised techniques do not require labeled data for training ML model(s) and can alternately be used to understand the context of conversation utterances or interaction messages, the performance of the unsupervised approaches cannot be comparable to that of supervised approaches. For using the supervised techniques, labeling is needed for a large number of messages for different contexts along with reviewing by domain experts. This requires time-consuming manual efforts, and thus greatly increase the processing time and development cycle.

The disclosure herein presents an augmented intelligence solution driven from natural language processing (NLP) and text mining to extract actionable insights from the interaction data of enterprise conversation interfaces. This technical solution works in tandem with domain expertise while leveraging insights generated from the algorithms. The technical solution further uses deep learning models in a multi-label and multi-class scenario. Advantageously, the technical solution described herein can accurately understand the context of conversation utterances regardless of the high volumes, high variabilities, and high informalities/errors of interaction messages. The technical solution can also reduce the blockage of insight generation from unlabeled data and implement context understanding in a timely manner.

Furthermore, the technical solution automatically tracks context at utterance level and improves feedback triggered action. With the feedback mechanism, the technical solution drives an online conversation in a manner that maximizes the probability of a goal being achieved in the conversation. Therefore, user experience in using a conversation interface is improved. Users will not divert to other systems to look for an answer that meets their goals. As a result, computer resources (e.g., processing time, memory) and network resources (e.g., network traffic, bandwidth) otherwise used in searching the answer can be reduced. Specifically, the time taken by users/consumers to obtain the required information or resolution is reduced. In addition, the technical solution is flexible and efficient as it can be extended to create automatic conversational AI systems with customized automatic response generation mechanism. By automatically identifying multiple contexts in customer interaction messages and preserving the order of multiple contexts in the customer messages in contextual understanding, the technical solution further helps improve the agent responses and increases the reliability of the conversation system. Moreover, the technical solution helps agents and contact centers to identify and track frequently asked questions and address customer pain points effectively.

Overall Interaction Data Processing with Contextual Understanding

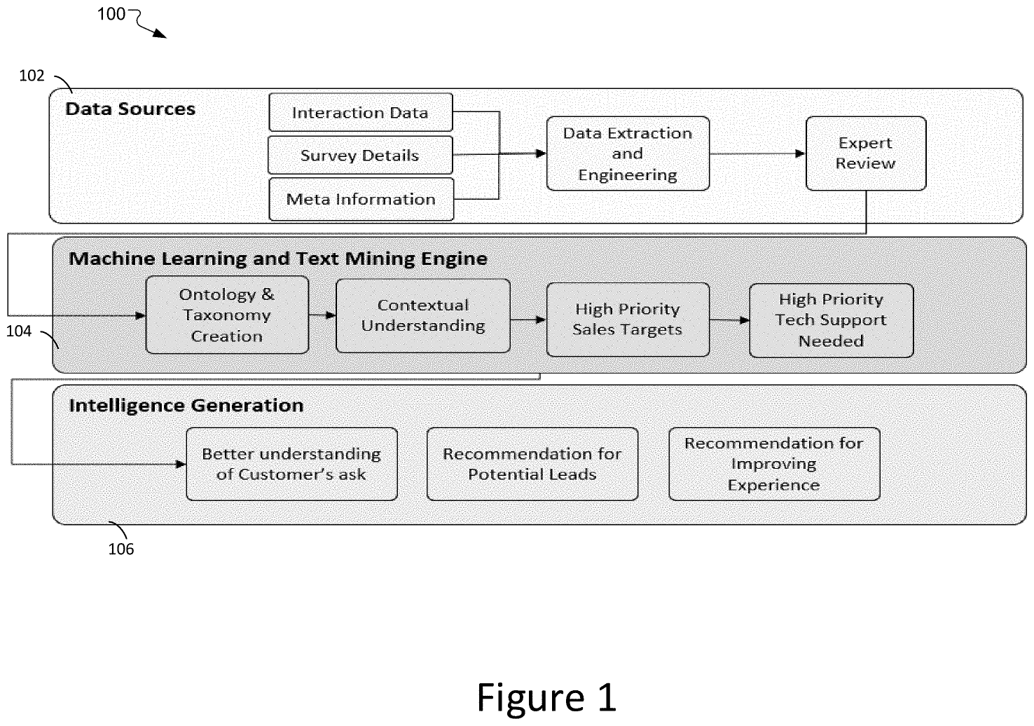

FIG. 1 illustrates an exemplary high-level functional view 100 for data processing based on contextual understanding, according to some embodiments. Advantageously, the present disclosure provides a technical solution that intelligently combines unsupervised and supervised approaches for ingesting robustness to contextual understanding of interaction messages/data ingested in conversation interfaces. While the present disclosure mainly focuses on the processing of conversation data, it should be noted that the approach described herein may also be applied to label and contextually understand other types of data.

As depicted in view 100, data is extracted from various data sources 102. The extracted data is transmitted to machine learning and text mining engine 104 for processing. Eventually, the processed data may cause intelligent contextual understanding to be determined in intelligence generation stage 106.

Data sources 102 include different types of data associated with a conversation interface, such as interaction data, survey data, or meta information. The interaction data can include interaction messages describing interaction between a user/customer with an agent of the conversation interface. An interaction message may be a text message, a voice message, a video message, an email, an online post, or other types of online messages. The agent may be an automated virtual agent or a human agent. The agent may be associated with a contact center that manages customer/consumer interactions across various channels. The survey data can be user feedback data regarding the user's experience of using the conversation interface. The meta information can include other data related to the conversation interface such as when a message was made, who made the message, from what device a user made the message, where the message was made, etc. The data from data source 102 is collected and engineered/processed. The processing at this stage may include data parsing, extraction, as well as theme and/or topic mining.

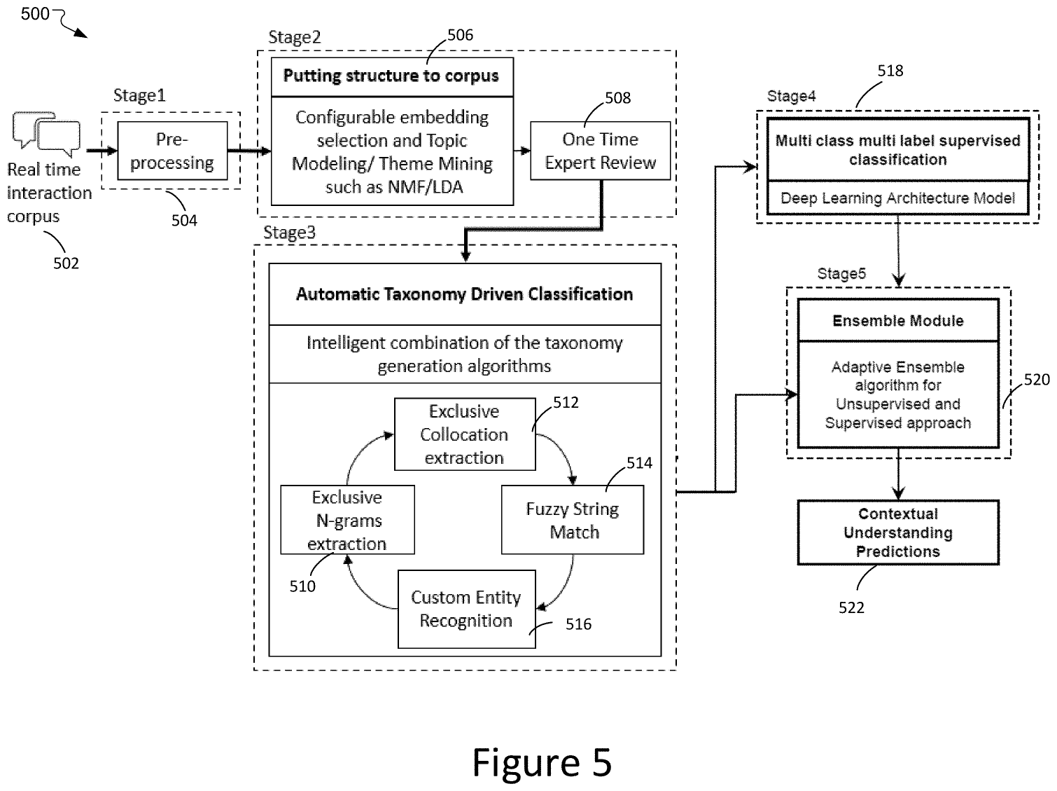

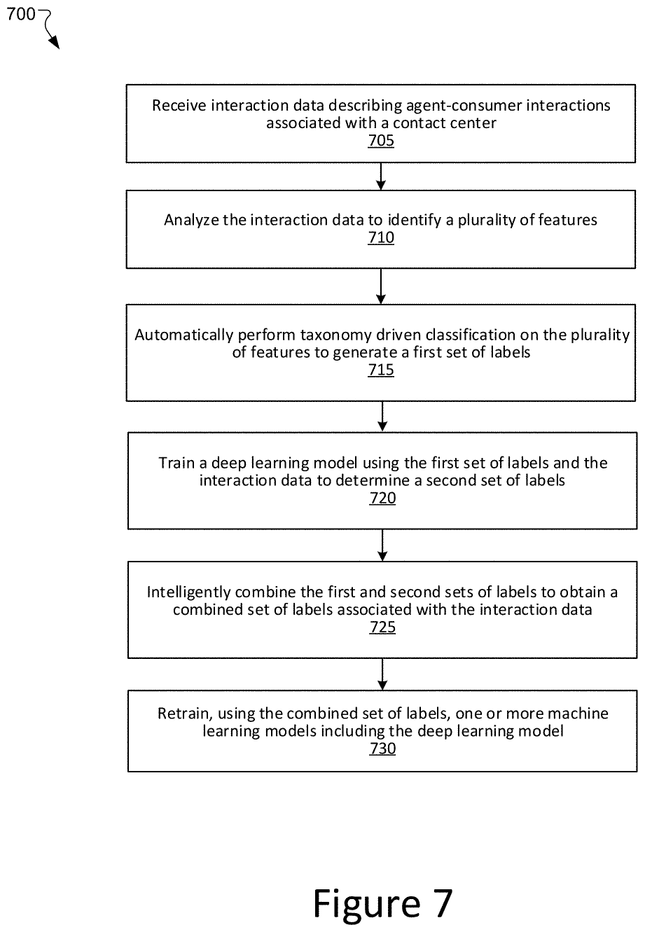

In some embodiments, the interaction data is provided to experts for review, refinement, optimization, and/or approval. Such experts may include developers, subject matter experts or organizations using the conversation interface. Based on the expert review, one or more ML models may be modified or supplemented to enhance the subsequent context understanding. Although the expert review may help improve the quality of context identification and understanding, the present disclosure balances the effort in expert review, e.g., limiting to one-time expert review as described below in FIGS. 5 and 7, to reduce the human intervention and effort required in the development of overall framework without impacting the performance of the system.

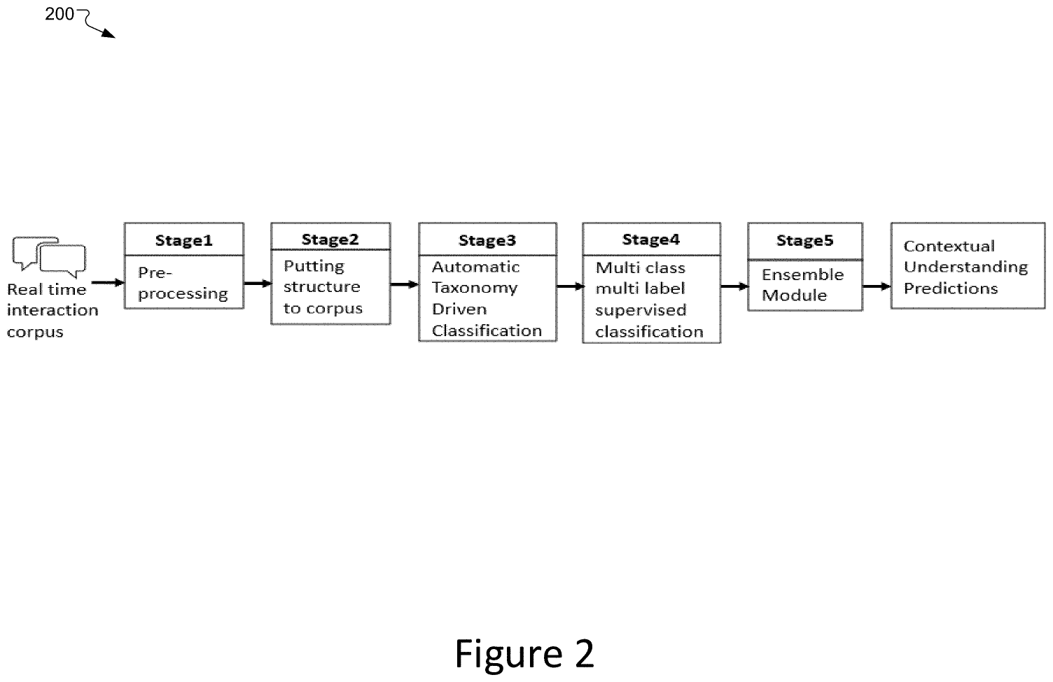

After the expert review, the interaction data is fed into machine learning and text mining engine 104 to perform ontology and taxonomy creation. In some embodiments, both supervised and unsupervised approaches are used by machine learning and text mining engine 104 to perform context identification and understanding. The labels determined from supervised and unsupervised ML approaches may be prioritized and combined to obtain a combined label set for each context (e.g., as reflected by high priority tech support in FIG. 1). The process of context identification and understanding will be described in detail with reference to FIGS. 2-8B.

In intelligence generation stage 106, the data of contextual identification and understanding from both supervised and unsupervised machine learning are combined and refined to better understand customer's questions and better serve the customer's needs. In intelligence generation stage 106, the data can also be combined and analyzed to provide recommendations for potential leads. For example, based on similar complaints from a large number of customers, an amusement park may be recommended to extend the open hours of one specific area. The data or analytics can further be used to provide recommendations that improve user experience in intelligence generation stage 106. For example, based on an average waiting time and/or an average number of waiting parents, the amusement park may consider providing more strollers for parents with little kids. It should be noted FIG. 1 is merely an exemplary illustration, other insights may be derived from the processing of the interaction data and other types of understandings or recommendations may be determined.

FIG. 2 illustrates an exemplary high-level technical view 200 for handling unlabeled interaction data with contextual understanding, according to some embodiments. The present disclosure proposes a five-stage approach for understanding one or multiple contexts from interaction messages. The flow of the five-stage approach starts with receiving real-time interaction corpus (e.g., from data source 102 in FIG. 1). A corpus of interaction data may include utterance(s) related to a query or command made by a user/customer in a conversation interface. In some embodiments, the corpus of interaction data is received and processed in real time when an ongoing conversation interface is progressing. In other embodiments, the dataset ingestion, i.e., receiving the interaction data, is an offline activity that is fed into the contextual understanding framework. In such a case, context detection may be performed at pre-defined intervals (e.g., periodically) to generate desired or required insights. In stage 1, the corpus of interaction data is pre-processed, for example, based on spelling correction, short-form or emoji handling, etc. The pre-processed data is then transmitted to stage 2 for parsing, extraction, and one time expert-review after one or more unsupervised approaches are applied on the interaction data. More importantly, in stage 2, structure is put to the corpus of interaction data using configurable word embeddings, topic modeling, and/or theme mining. As a result, the unstructured data can be categorized into some structured categories (e.g., based on topics or themes). In some embodiments, operations in stages 1 and 2 correspond to the processing in data source 102 of FIG. 1.

In stage 3, taxonomy based classification is implemented on the interaction data categorized into some structured categories. Taxonomy identifies and classifies the interaction data into a hierarchical structure to be analyzed. For example, an automated, AI-driven approach may be used to classify and tag the content of interaction data with hierarchical context. Specifically, unsupervised machine learning can be leveraged to capture key features of the interaction data. This is in addition to analyzing content, identifying keywords, and organizing and tagging words and phrases of the interaction data. In stage 3, operations are streamlined for filtering domain/context and respective taxonomy obtained from unsupervised approaches, which is particularly useful to achieve a primary goal of the present disclosure for reducing human intervention. Further, stage 3 operations based on unsupervised techniques act as the backbone for building a supervised classifier in stage 4. Upon receiving the taxonomy based classification from stage 3 as an input, stage 4 can build the output as multi-label and multi-class supervised classification. In some embodiments, operations in stages 3 and 4 correspond to the machine learning and text mining 104 in FIG. 1.

The final stage or stage 5 of FIG. 2, in some embodiments, corresponds to intelligence generation portion 106 in FIG. 1. In this stage 5 for contextual understanding, the prominent features captured from unsupervised approaches (e.g., at stage 3) along with supervised learning (e.g., at stage 4) are combined to determine combined label(s) and context associated with each interaction message in the conversation. The determined context helps improve the development of the virtual agents (e.g., improving the agent's ability to handle domain/context specific nuances). The operations of these five stages will be described in detail in FIG. 5.

Domain understanding is vital to build automatic responses or suggestions for virtual agent of conversation interfaces. Conventional rule-based conversation systems require manually labelled training data for the systems to learn the communication rules for each specific domain. The five-stage approach as described in FIG. 2, however, minimizes the manual operations (e.g., only one-time expert review) to enhance the domain understanding, which reduces expensive human-labeling efforts and costs.

Additionally, the scarcity of labeled data may impact model building in conversation systems. The five-stage approach of FIG. 2 first uses unsupervised ML technique to capture the key features of the interaction data and then uses supervised ML techniques to automatically refine and model the key features, which intelligently solves the problem of lacking labeled data in ML modeling.

Context detection is critical to generate insights and improve customer experience. The five-stage approach of FIG. 2 creates an automatic labeling process (except one-time expert review) for interaction data received from a conversation interface, and uses the data set improved with the automatic labeling to retrain ML model(s) that drives the conversation interface to improve insight generation. Rather than extending the capability of a conversation interface, the five-stage approach retrieves the interaction data from conversation interfaces and performs the unsupervised and supervised ML learning analysis on the interaction data to identify pattern(s) and determine context to benefit and improve the conversation interface in the long run. For example, this approach can analyze the past interaction data (e.g., within the last N months) received from a conversation interface to enhance insight generation. The generated insights may include: what is the most discussed topic, what is customer's viewpoint, what can be adjusted to improve user experience, whether there is any alarm derived from the data, etc. In some embodiments, a feedback mechanism may also be provided to the conversation interface framework. The enhanced insight generation together with the feedback mechanism can be advantageous in improving both conversation interface performance and user experience.

### Computer Implementation

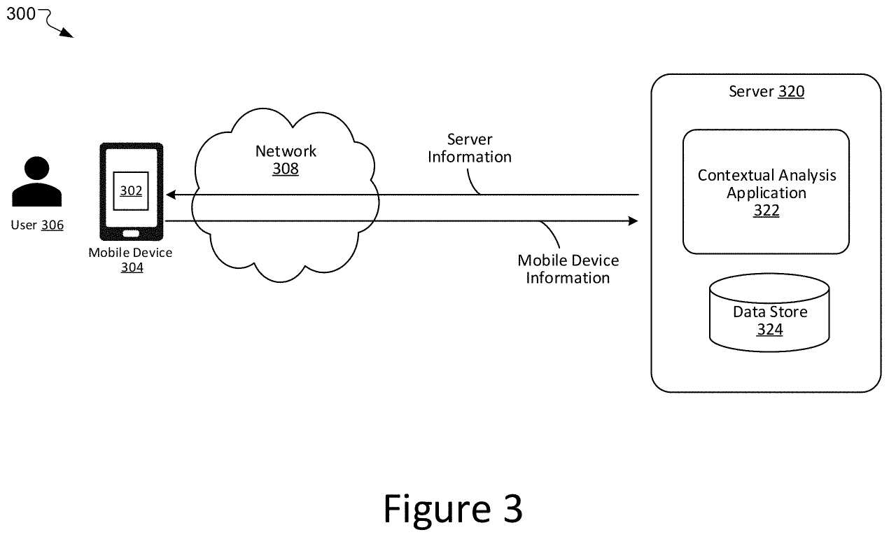

FIG. 3 is a system 300 for data processing based on contextual understanding, according to some embodiments. By way of example and not limitation, the methods described herein (e.g., functional view 100 in FIG. 1) may be executed, at least in part, by a software application 302 running on mobile device 304 operated by a user or customer 306. By way of example and not limitation, mobile device 304 can be a smartphone device, a tablet, a tablet personal computer (PC), or a laptop PC. In some embodiments, mobile device 304 can be any suitable electronic device connected to a network 308 via a wired or wireless connection and capable of running software applications like software application 302. In some embodiments, mobile device 304 can be a desktop PC running software application 302. In some embodiments, software application 302 can be installed on mobile device 304 or be a web-based application running on mobile device 304. By way of example and not limitation, user 306 can be a person that intends to achieve a specific goal such as requesting a service, conducting a transaction, seeking an answer for a question, etc., using conversation interface. The user can communicate with server 320 via software application 302 residing on mobile device 304 to receive responses from conversation interface(s) that meet his/her specific goal or needs.

Network 308 can be an intranet network, an extranet network, a public network, or combinations thereof used by software application 302 to exchange information with one or more remote or local servers, such as server 320. According to some embodiments, software application 302 can be configured to exchange information, via network 308, with additional servers that belong to system 300 or other systems similar to system 300 not shown in FIG. 3 for simplicity.

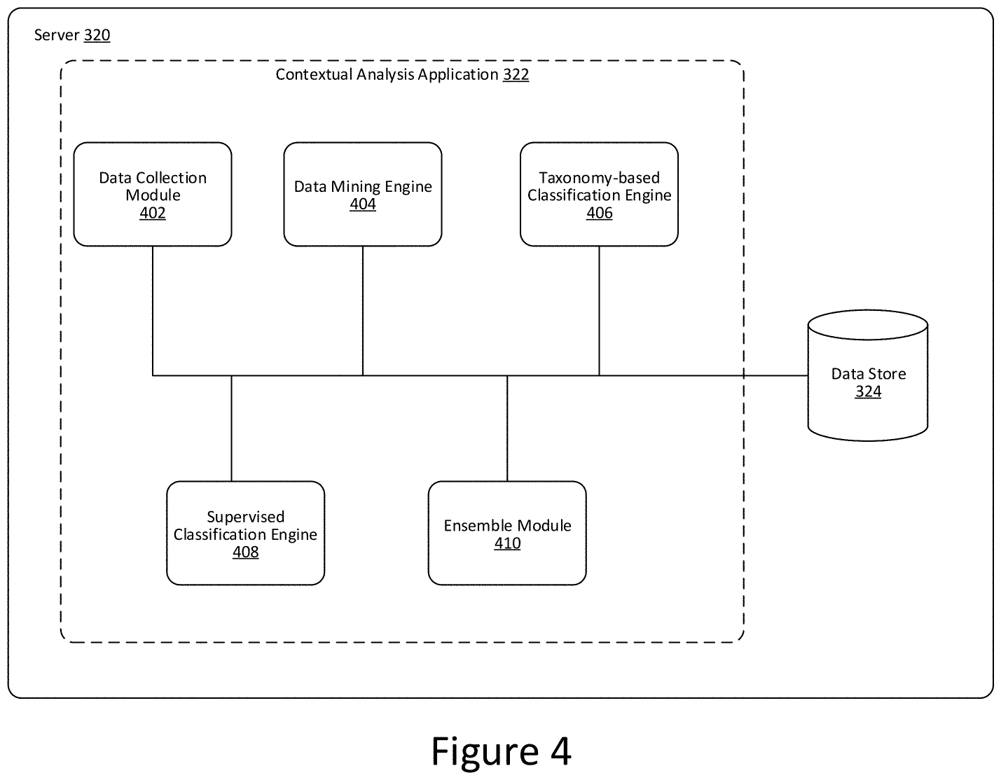

In some embodiments, server 320 is configured to store, process and analyze the information received from user 306, via software application 302, and subsequently transmit in real time processed data back to software application 302. Server 320 can include a contextual analysis application 322 and a data store 324, which each includes a number of modules and components discussed below with reference to FIG. 4. Server 320 can also include an agent (e.g., automated/virtual agent, human/live agent) to provide conversation service, and contextual analysis application 322 is part of the virtual agent. According to some embodiments, server 320 performs at least some of the operations discussed in the methods described herein (e.g., functional view 100 in FIG. 1). In some embodiments, server 320 can be a cloud-based server.

In some embodiments, FIG. 4 depicts selective components of server 320 used to perform the functionalities described herein, for example, operations of functional view 100. Server 320 may include additional components not shown in FIG. 4. These additional components are omitted merely for simplicity. These additional components may include, but are not limited to, computer processing units (CPUs), graphical processing units (GPUs), memory banks, graphic adaptors, external ports and connections, peripherals, power supplies, etc., required for the operation of server 320. The aforementioned additional components, and other components, required for the operation of server 320 are within the spirit and the scope of this disclosure.

In the illustrated embodiment of FIG. 4, server 320 includes a contextual analysis application 322 and a data store 324. Contextual analysis application 322 in turn includes one or more modules responsible for processing and analyzing the information received by server 320. For example, the modules in contextual analysis application 322 may have access to the chat messages from user 306 in a conversation interface, and generate a response based on the context identified from the received chat messages. Typically, contextual analysis application 322 is part of the virtual agent residing on server 320.

In some embodiments, contextual analysis application 322 of server 320 includes a data collection module 402, a data mining engine 404, a taxonomy-based classification engine 406, a supervised classification engine 408, and an ensemble module 410. In some embodiments, contextual analysis application 322 of server 320 may include only a subset of the aforementioned modules or include at least one of the aforementioned modules. Additional modules may be present on other servers communicatively coupled to server 320. For example, taxonomy-based classification engine 406 and supervised classification engine 408 may be deployed on separate servers (including server 320) that are communicatively coupled to each other. All possible permutations and combinations, including the ones described above, are within the spirit and the scope of this disclosure.

In some embodiments, each module of contextual analysis application 322 may store the data used and generated in performing the functionalities described herein in data store 324. Data store 324 may be categorized in different libraries (not shown). Each library stores one or more types of data used in implementing the methods described herein. By way of example and not limitation, each library can be a hard disk drive (HDD), a solid-state drive (SSD), a memory bank, or another suitable storage medium to which other components of server 320 have read and write access.

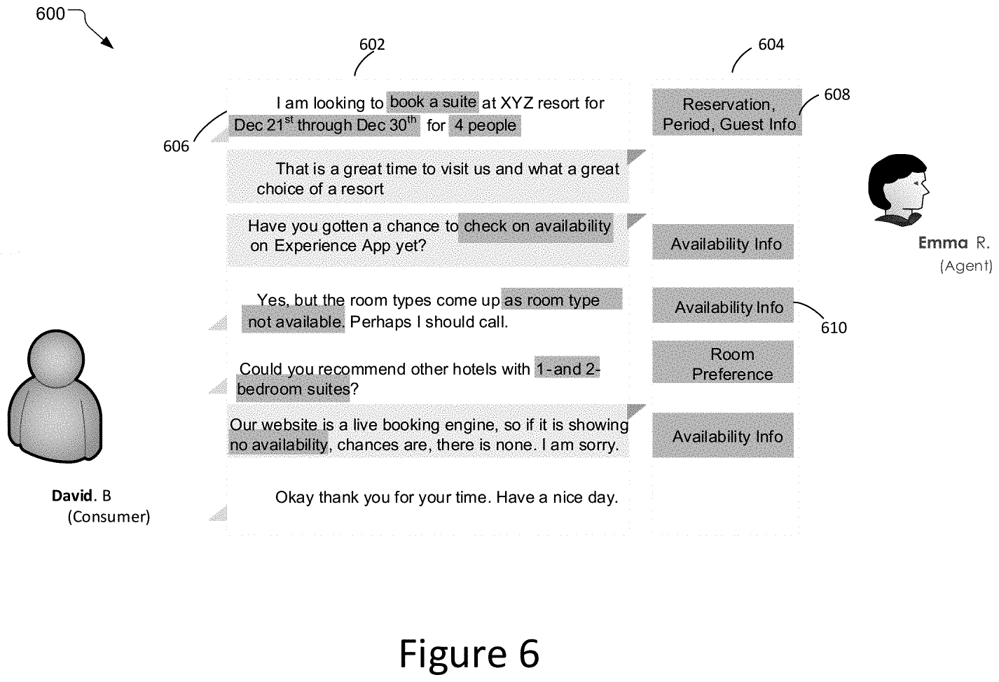

Although not shown in FIG. 4, server 320 may include an AI manager to provide a conversation platform for users, a user interface engine to generate conversation interfaces for display on the mobile device 304, etc. For simplicity and clarity, these backend supporting components will not be described separately in this disclosure. Also, various functionalities performed by contextual analysis application 322 of server 320 in communication with mobile device 304 as well as other components of system 300 will mainly be described in accordance with the architecture shown in FIG. 5 and with reference to other FIGS. 6-8B.

Interaction Data Processing with Contextual Understanding

FIG. 5 illustrates an example architecture 500 for processing unlabeled interaction data based on contextual understanding, according to some embodiments. The architecture in FIG. 5 elaborates the five-stage approach in FIG. 2. This approach leverages multiple unsupervised techniques along with supervised techniques to provide an efficient and reliable solution for contextual understanding of conversation interfaces. The proposed pipeline also significantly reduces human efforts in labeling and dependency on expert review. Further, the five-stage approach allows the labeled data preparation required for training supervised technique to be greatly streamlined and semi-automated.

### Stage 1: Pre-Processing

A chatbot is a communication channel that helps an agent (e.g., a service provider) in a conversation interface to interact with end-users and provides an answer or a solution that achieves a specific goal of a user. The conversation interface handles the conversations with the end-users through various components of contextual analysis application 322. As depicted in FIG. 5, the conversation interface processing starts at stage 1, where data collection module 402 of contextual analysis application 322 collects real-time interaction corpus 502 for pre-processing 504. The interaction corpus 502 includes at least interaction data, survey data and/or meta information (as depicted in FIG. 1). The interaction data can be any data describing interaction between a user and a live/virtual agent, such as data that the user voluntarily offered in a conversation interface or data that the user replied to questions from the agent. The survey data is related to user feedback about his/her experience of using the conversation interface. The meta information can be any data that provides information of the interaction data (e.g., time, location, user identifier).

The interaction corpus may include unlabeled raw data/text from the conversation interfaces, i.e., utterances from a user/customer. Pre-processing the raw text is critical to the subsequent effective model building (e.g., in stages 3 and 4). In some embodiments, data collection module 402 may perform at least one of the following pre-processing operations:
Converting text to lower-case
Part-of-Speech (POS) tagging
Short forms handling
Extra white space removal
Expanding contractions
Stop word removal
Applying spell-correction
Stemming or lemmatization
Removal of single character tokens
Removal of non-ascii characters and punctuations
URL and formatting tags removal
Emoji handling

The pre-processing pipeline is configurable. In some embodiments, data collection module 402 may select and customize the pre-processing operations based on the analysis of interaction data. For example, data collection module 402 would skip emoji handling if the interaction data includes few emojis. Data collection module 402 may also adjust the pre-processing operations based on the use scenario/case associated with a conversation. For example, if a conversation is about an online product purchase, data collection module 402 may perform URL and formatting tags removal when pre-processing the website information of the vendor in the online purchase.

### Stage 2: Putting Structure to Corpus and One-Time Expert Review

Once the corpus of interaction data is pre-processed, data collection module 402 transmits the pre-processed data to data mining engine 404 to put 506 structure to the corpus in stage 2, that is, leveraging the unsupervised learning techniques such as word embeddings, topic modeling or theme mining to obtain key/prominent features from the interaction data. The topic modeling can compute words and document embeddings and help to perform clustering of the interaction data. The theme mining can examine the interaction data to identify common themes such as topics, ideas and/or patterns of meaning that are prominent. These topics are leveraged in contextual understanding.

In some embodiments, data mining engine 404 may perform topic modeling and/or theme mining to identify a pre-defined list of topics and relevant n-grams (e.g., any sequence of n words). Based on different use cases associated with the interaction data (e.g., different types of interaction data), data mining engine 404 may select different algorithms and vectorization to perform topic modeling and/or theme mining. For example, the algorithms can be non-negative matrix factorization (NMF) or latent dirichlet allocation (LDA). The text representation can be based on term frequency (TF), inverse document frequency (IDF), document frequency (DF), or appropriate embeddings (e.g., pre-trained or trained from dataset) technique. Responsive to identifying topic(s) and/or theme(s) to determine prominent features, in some embodiments, data mining engine 404 may provide labeling or taxonomy suggestion(s) for one-time expert review 508.

The interactions between a customer and an agent are usually focused on specific context related to product inquiries/transactions or issue reporting/tracking. A subject matter expert (SME) can define the various context specific to a domain of interaction data as a one-time activity. Instead of going through the entire interaction data and search patterns for labeling the data, the present disclosure is able to present the SME with suggested taxonomy or multiple labeling suggestions such that the SME can quickly and easily finalize the taxonym and/or refine label suggestions.

The expert review 508 is the one-time activity of human involvement in the whole end-to-end process as described in the present disclosure. The expert review may help data refinement and be used to adjust the ML model building. For example, an appeared-to-be important feature may be identified as not important by the SME (e.g., based on a conflict with an enterprise policy), and is removed from the model building at this early stage. As a result, the model building is improved, and the corresponding computing cost and processing time are reduced. Additionally, the amount of time used in expert review based on labeling or taxonomy suggestion(s) is shortened. Further, the expert review is made to be a one-time activity to minimize the impact of manual operation in system automation.

### Stage 3: Automatic Taxonomy Driven Classification

In stage 3, further data refinements are performed, i.e., taxonomy-based classification engine 406 may perform automatic taxonomy driven classification to further limit the number of key features (e.g., topics, n-grams) identified from stage 2. Specifically, taxonomy-based classification engine 406 intelligently combines multiple unsupervised approaches to understand context and further generates taxonomy (e.g., labels) for each context. Since each unsupervised technique has specific advantages and limitations, in stage 3, taxonomy-based classification engine 406 may combine various algorithms in a custom pipeline to enhance the performance of contextual understanding. In other words, depending on different use cases or different types of interaction data, one or more different algorithms can be intelligently configured and incorporated according to an ensemble logic (not shown) to perform automatic taxonomy generation. Even the order to perform the various algorithms can be configured and changed per use case in order to optimize the performance of individual and combined algorithms. In some embodiments, taxonomy-based classification engine 406 may use one or more of the algorithms including exclusive n-grams extraction 510, exclusive collocation extraction 512, fuzzy string match 514, and custom named entity recognition 516, to enhance the taxonomy created.

An unsupervised taxonomy generation algorithm is exclusive n-gram extraction 510. An n-gram denotes a sequence of n words. For example, an n-gram consisting of two words is a bi-gram, and an n-gram consisting of three words is a trigram. In some embodiments, taxonomy-based classification engine 406 may determine a number of contexts and a set of n-grams in each context, and identify common features, prominent features and/or exclusive features based at least in part on intersections of the set of n-grams. An example exclusive n-gram extraction algorithm is shown below:
If p=p₁, p₂, p₃, . . . , pᵢ is number of contexts then k=k1∪k2 . . . ∪ki is set of n-grams respectively.

Common_features=k1∩k2∩ . . . ∩ki

pi_prominent_features=ki−Common_features

pi_Compliment=k−ki (excluding the i^{th} set)

pi_exclusive=pi_prominent_features−pi_Compliment

Suppose three contexts “amenities,” “hotels,” “and “sales” are identified from the interaction data in a resort booking conversation. The n-grams for each context list below:
Amenities: pet-friendly, pool, fitness center, and sales support;
Hotels: pool, conference room, and sales support;
Sales: sales support, and payment mode.

A common feature is a feature showing in each different context. For example, the common feature between the three contexts is “sales support.” A prominent feature is a feature that is particular to a context. For example, the prominent feature of “sales” is “payment mode.” A compliment feature is a feature that is not particular to a context, but still present in that context. For example, the “pool” feature is a compliment feature for the hotel context. It is present in both the context of “amenities” and “hotels.” An exclusive feature is a prominent feature that is particular only to a particular context, that is, a unique feature of the particular context. In this example, the “amenities” context has the exclusive features of “pet-friendly” and “fitness center.” The “hotels” context has the exclusive feature of “conference room.” The “sales” context has the exclusive feature of “payment mode.”

By analyzing different types of features, taxonomy-based classification engine 406 can assign multiple labels to a context. These labels can be unique or non-unique to a particular context. By analyzing the unique or non-unique labels, taxonomy-based classification engine 406 can further determine analytics that helps enhance the contextual understanding and insight generation (e.g., hot discussion).

Another unsupervised taxonomy generation algorithm is exclusive collocation extraction 512, where exclusive collocations can be separately extracted from a corpus of interaction data. Collocations can be extracted based on each context using one or more vectorization techniques. Collocations are n-grams that provide both the intended meaning and the co-occurrence of bi-grams or tri-grams in the corpus of interaction data.

In some embodiments, multiple approaches can be used to detect and statistically analyze the co-occurrence of bi-grams or tri-grams in the corpus of interaction data. Taxonomy-based classification engine 406 may count frequencies of adjacent words in the data (e.g., utterances). The word occurring more frequently is considered to be more meaningful. Particularly, a combination of words occurs frequently together. Taxonomy-based classification engine 406 may also obtain pointwise mutual information (PMI), and determine whether the co-occurrence of certain words is more than the individual occurrence of each word. The co-occurrence of collocation/n-grams can also be determined based on hypothesis testing, for example, T-test or Chi-square test, with null hypothesis of words being independent. Taxonomy-based classification engine 406 may further determine the likelihood of the co-occurrence of collocation, by comparing the frequency of co-occurrence of certain words to the frequencies of independent word of the certain words in a document. Using the determined co-occurrence information and the aforementioned approach for extracting exclusive n-grams, taxonomy-based classification engine 406 can perform exclusive collocations extraction 512.

To enhance the taxonomy, taxonomy-based classification engine 406 can also use the solution of fuzzy string matching 514 to find strings that approximately match a pattern. In some embodiments, taxonomy-based classification engine 406 can generate all the possible fuzzy phrases present in the interaction data or utterance message for every expression in a dictionary, e.g., determining A, B and C phrases used by a particular user in a conversation all represent the same expression D. Taxonomy-based classification engine 406 can automatically select the possible fuzzy phrases by examining the inflection for all the words in the phrases. In some embodiments, taxonomy-based classification engine 406 also combines the fuzzy phrases without whitespaces to eliminate duplicate phrases.

Taxonomy-based classification engine 406 may recognize custom named entities to further enhance the taxonomy. In a conversation, a user is very likely to refer to his/her name, company name, product name, street, city, etc. Taxonomy-based classification engine 406 may take a special way, e.g., custom entity recognition 516, to process such named entities. In some embodiments, taxonomy-based classification engine 406 uses the available taxonomy with associated contexts to train a custom entity recognition model. For example, this machine learning model can be trained using a transition-based parser. The transition-based parser is used in structured prediction by mapping the task of prediction to series of transitions.

### Stage 4: Supervised Classification

In stage 2, the meaningful/prominent features are identified and further reviewed by SME/experts to obtain the seed fed into stage 3. The seed is the structured interaction data categorized based on topics and/or themes. In stage 3, for different structured interaction data in different use cases, different types of unsupervised analysis such as exclusive n-grams extraction 510, exclusive collocation extraction 512, fuzzy string match 514, and custom named entity recognition 516, are configured and performed to enhance the taxonomy (e.g., labels). At this point, both unsupervised approaches have been applied to the interaction messages and the labels detected have been reviewed by experts. The contexts are labeled with the required effort being reduced. In stage 4, the context-labeled utterances received from stages 2 and 3 are transmitted to supervised classification engine 408, and are then used to train deep learning model(s) 518 for refining labeling and contextual understanding.

In some embodiments, the output of stage 3 is fed into deep learning supervised model(s) to perform multi-class and multi-label classification for context identification by supervised classification engine 408. Based on multi-class classification, supervised classification engine 408 may determine mutually exclusive context from the interaction data. For example, supervised classification engine 408 may associate a conversational utterance with multiple contextual labels such as animal, date, and weather. These labels represent exclusive content. Based on multi-label classification, supervised classification engine 408 may predict multiple mutually non-exclusive classes or labels. For example, supervised classification engine 408 may associate a conversational utterance with multiple contextual labels such as sports, finance, and politics. These labels represent some overlapping content.

In addition to detecting multiple contexts within the same conversation, in some embodiments, supervised classification engine 408 may also detect and preserve the order of various contexts discussed in the conversation. It may be important whether a customer first talks about price or date when booking a flight ticket. If the first is price, then the ticket with a lowest price may be what the customer needs. Otherwise, the customer may want to travel on a certain date with a relatively higher priced ticket. The order therefore can also be critical to accurately label and contextual understanding of the conversation. It should be noted that the unsupervised taxonomy/label generation in stage 3 also detects multiple contexts within the same conversation, and preserve the order of various contexts discussed in the conversation. An example of multiple context detection will be described in FIG. 6.

The deep learning model(s) 518 utilized by supervised classification engine 408 may include a feed forward neural network, a convolution neural network (CNN), or the like. In some embodiments, supervised classification engine 408 can configure and adjust the supervised learning algorithms and associated ML model(s) (e.g., parameters, order) based on different use cases/types of the conversations.

### Stage 5: Ensemble Contextual Labels

The output of both supervised learning operations in stage 4 and unsupervised learning operations in stage 3 are intelligently combined in the ensemble logic of stage 5 for ingesting robustness to contextual understanding. In stage 3, the output may include features and/or labels from the NLP based pattern matching driven by domain taxonomy. In stage 4, the output may include features and/or labels from deep learning-based multi-class and multi-label supervised classifiers for contextual understanding. In the final stage 5, ensemble module 410 may infer contexts from the combined messages using an adaptive ensemble algorithm 520. For example, ensemble module 410 may be configured to combine the labels predicted at the unsupervised level and the labels predicted at the supervised level based on respective weights to output contextual understanding predictions 522. In some embodiments, ensemble module 410 communicates with at least one of data mining engine 404, taxonomy-based classification engine 406, or supervised classification engine 408 to retrain one or more machine learning models (e.g., a deep learning model) to enhance contextual understanding of conversations associated with the conversation interfaces and improve insight determination.

Multi-class classification can handle two or more classes, whereas multi-label classification can associate multiple labels to a single instance. Multi-class and multi-label classification in stage 4 help various contexts to align with multiple n-grams present in interaction messages. Ensemble module 410 in stage 5 detects one or more contexts for the same interaction, e.g., outputting one or more contextual labels for a conversational utterance. The combination of unsupervised techniques (e.g., stage 3) with minimal expert review (stage 2) and supervised classification (stage 4) enhances the overall performance of the end-to-end contextual understanding solution for conversations. The technical solution described herein not only minimizes human intervention in labeling and shortens the development cycle, but also enhances accurate contextual understanding during interactions.

FIG. 6 is an example interface 600 illustrating contextual understanding of utterances associated with agent-consumer interactions, according to some embodiments. In the example interface 600, utterances 602 in the left dash-lined box may be taken from the chat transcript of a conversation from a conversation interface. The conversation is between an agent Emma and a customer David about booking a suite at a resort. The chat transcript is analyzed line by line to identify and label context(s). The key feature(s) extracted and identified from each line of the utterance based on the contextual analysis is highlighted in utterances 602. The label(s) associated with each key feature of the utterances is shown in the right dash-lined box of 604. For example, the contextual analysis of utterance 606 shows three key features: the reason (e.g., “book a suite”), date (e.g., “December 21^{st} through December 30^{th}”), and the size of a group (e.g., “4 people”). Accordingly, utterance 606 is assigned with three labels “Reservation,” “Period,” and “Guest Info” in 608. Each of the labels represents a user intention specified in the utterance/interaction data leveraging contextual understanding. As the conversation between David and Emma proceeds, more utterances are analyzed, and more labels are generated. As a result, various types of insights may be generated to improve future contextual understanding.

In some embodiments, the contextual analysis is implemented in two-levels. In the first level, as reflected in utterances 606, multiple contexts may be determined from one utterance line. Often, the order of the features in the utterance(s) of the conversation from a conversation interface is also detected. In the second level, analytics are determined based on the detected features and order. For example, statistical analytics associated with each label can be determined, such as how many customers want to book the resort between December 21^{st} and 30^{th}. The order of the features is also important to understand the context. For example, the “Period” label in 608 may affect the analysis of the “Availability Info” in 610. If a large number of customers are talking about booking the resort from December 21^{st} through December 30^{th}, then availability arrangement may be made to accommodate the high demand during those days. This facilitates the contextual analysis and insight generation, and enhances accurate contextual understanding during interactions.

FIG. 7 illustrates an exemplary general process 700 for identifying and refining contextual labels of interaction data from a conversation interface, according to some embodiments. In some embodiments, contextual analysis application 322 of server 320 as depicted in FIG. 4 in communication with other components of system 300 implements process 700. At step 705, contextual analysis application 322 receives interaction data associated with a contact center. The interaction data can be any data describing interaction between a user and a live/virtual agent, such as data that the user voluntarily offered in the conversation interface or data that the user replied to questions from the agent. In the case of virtual agent, the responses are auto-generated.

At step 710, contextual analysis application 322 analyzes the interaction data to identify a plurality of features. For example, contextual analysis application 322 may leverage unsupervised learning techniques such as topic modeling or theme mining to obtain key/prominent features from the interaction data. At step 715, contextual analysis application 322 automatically performs taxonomy driven classification on the plurality of features to generate a first set of labels. The taxonomy driven classification may include one or more of algorithms including exclusive n-grams extraction, exclusive collocation extraction, fuzzy string match, or custom named entity recognition.

At step 720, contextual analysis application 322 trains a deep learning model using the first set of labels and the interaction data to determine a second set of labels. In some embodiments, the output of the automatic taxonomy driven classification is fed into the deep learning supervised model to perform multi-class and multi-label classification. Based on multi-class classification, mutually exclusive context may be determined from the interaction data. Based on multi-label classification, multiple mutually non-exclusive classes or labels may be predicted.

At step 725, contextual analysis application 322 intelligently combines the first and second sets of labels to obtain a combined set of labels associated with the interaction data. For example, contextual analysis application 322 may infer contexts from the combined messages using an adaptive ensemble algorithm. At step 730, contextual analysis application 322 retrains, using the combined set of labels, one or more machine learning models including the deep learning model to enhance contextual understanding of conversation associated with the conversation interfaces.

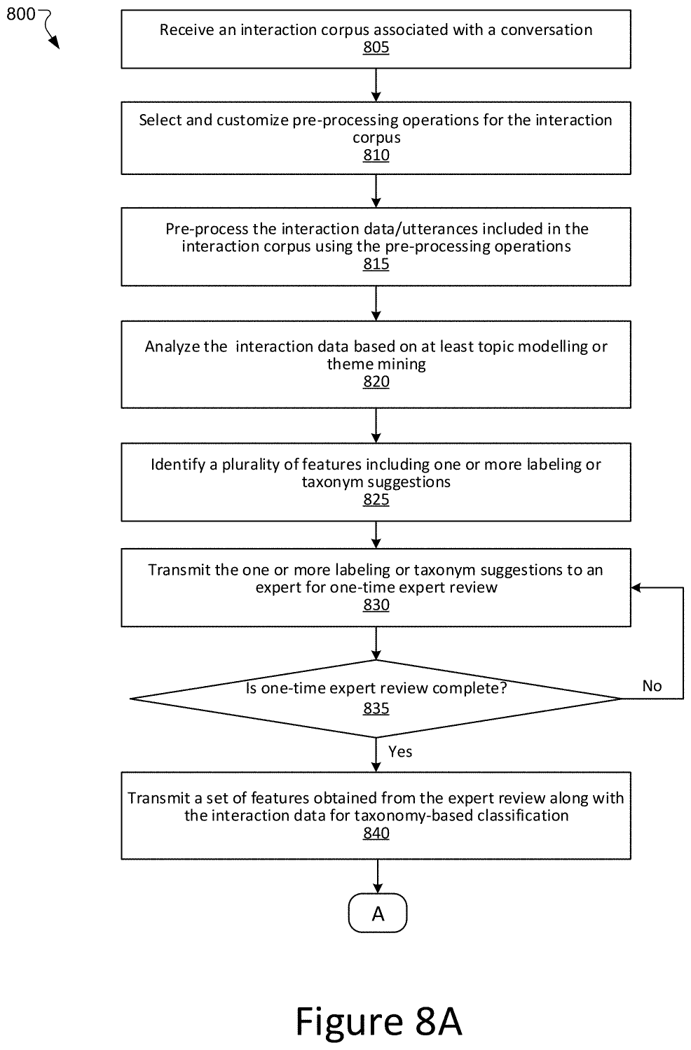

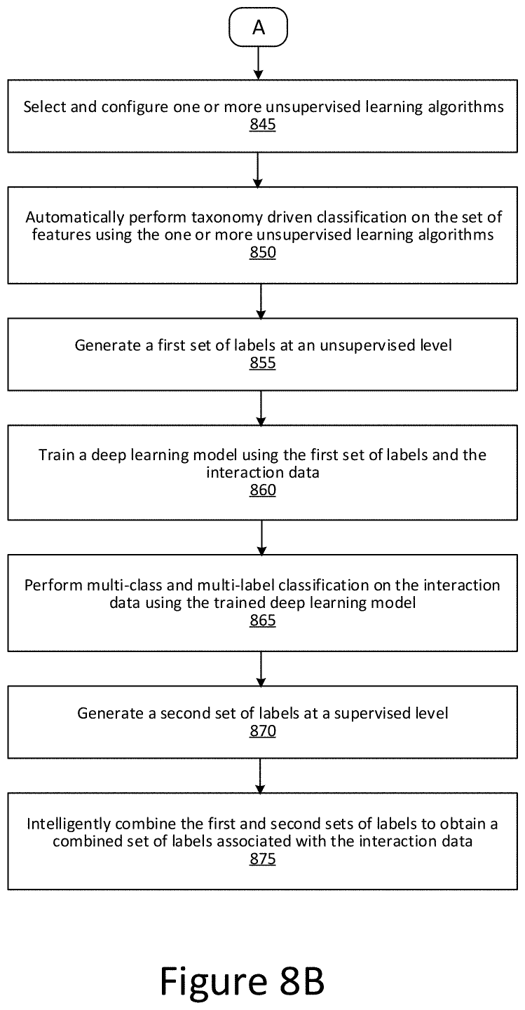

FIGS. 8A and 8B illustrate an exemplary specific process 800 for identifying and refining contextual labels of interaction data from a conversation interface, according to some embodiments. In some embodiments, contextual analysis application 322 of server 320 as depicted in FIG. 4 in communication with other components of system 300 implements process 800. Process 800 corresponds to the five-stage approach in FIGS. 2 and 5, where FIG. 8A includes operations of the first two stages and FIG. 8B includes operations of the last three stages.

At step 805, contextual analysis application 322 receives an interaction corpus associated with a conversation from a conversation interface. The interaction corpus may include interaction data describing the interaction between a customer and a live/virtual agent, survey data that is related to user feedback about his/her experience of using the conversation interface, and meta information that provides information of the interaction data (e.g., time, location, user identifier).

At step 810, contextual analysis application 322 selects and customizes pre-processing operations for the interaction corpus, for example, based on the nature of the interaction data. The nature of the data may include emojis, short forms, etc. At step 815, contextual analysis application 322 pre-processes the interaction data included in the interaction corpus (e.g., at utterance level) using the pre-processing operations.

The pre-processed data is transmitted to the next stage for further processing. At step 820, contextual analysis application 322 analyzes the interaction data based on at least topic modeling or theme mining, for example, using algorithms including non-negative matrix factorization (NMF) or latent dirichlet allocation (LDA). Responsive to identifying topic(s) and/or theme(s), at step 825, contextual analysis application 322 may identify a plurality of features including one or more labeling or taxonomy suggestions.

At step 830, contextual analysis application 322 transmits the one or more labeling or taxonomy suggestions to an expert for one-time expert review. The expert review 508 is the one-time activity of human involvement in the whole end-to-end process as described in the present disclosure. The expert review may help data refinement and be used to adjust the ML model building. In addition, the expert review is based on labeling or taxonomy suggestion(s) and can be completed in a short time. Further, the expert review is made to be a one-time activity to minimize the impact of manual operation in system automation. At step 835, it is determined whether the expert review is complete. Once it is complete, at step 840, contextual analysis application 322 transmits a set of features obtained from the expert review along with the interaction data for taxonomy-based classification. In some embodiments, the set of features can be a subset of the plurality of features.

Referring to FIG. 8B, at step 845, contextual analysis application 322 selects and configures one or more unsupervised learning algorithms, for example, based on the use case or the type of the interaction data. At step 850, contextual analysis application 322 automatically performs taxonomy driven classification on the set of features using the one or more unsupervised learning algorithms for contextual understanding. For example, the one or more unsupervised learning algorithms can be exclusive n-grams extraction, exclusive collocation extraction, fuzzy string match, or custom named entity recognition. At step 855, contextual analysis application 322 generates a first set of labels using the one or more unsupervised learning algorithms, e.g., at an unsupervised level.

At step 860, contextual analysis application 322 trains a deep learning model using the first set of labels and the interaction data. The deep learning model may include a feed forward neural network, a convolution neural network (CNN), a recurrent neural network (RNN), etc. At step 865, contextual analysis application 322 performs multi-class and multi-label classification on the interaction data using the trained deep learning model. At step 870, contextual analysis application 322 generates a second set of labels using one or more supervised learning algorithms, e.g., at a supervised level. In some embodiments, contextual analysis application 322 can configure and adjust the supervised learning algorithms and associated ML model(s) (e.g., parameters, order) based on different use cases/types of the conversation. Also, contextual analysis application 322 can detect multiple contexts within an utterance of the interaction data, detect an order of the multiple contexts in the interaction data, and generate the second set of labels based on analyzing the multiple contexts and the order. At step 875, contextual analysis application 322 intelligently combines the first and second sets of labels to obtain a combined set of labels associated with the interaction data.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated and described with the figures above. Modules may constitute either software modules (e.g., code embodied on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processors) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” is employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for the system described above. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for handling unlabeled interaction data with contextual understanding, the method comprising:
receiving the interaction data describing agent-consumer interactions associated with a contact center;
analyzing the interaction data to identify a plurality of features;
automatically performing taxonomy driven classification on the plurality of features to generate a first set of labels associated with the interaction data;
training a deep learning model using the first set of labels and the interaction data to determine a second set of labels;
intelligently combining the first and second sets of labels to obtain a combined set of labels associated with the interaction data; and
retraining, using the combined set of labels, one or more machine learning models including the deep learning model to enhance contextual understanding of the agent-consumer interactions associated with the contact center.

2. The method of claim 1, wherein analyzing the interaction data comprises:
configuring and performing at least one of word embeddings, topic modeling, or theme mining;
categorizing the interaction data into a list of topics or relevant n-grams; and
identifying the plurality of features based on categorizing the interaction data.

3. The method of claim 1, wherein the plurality of features comprises one or more taxonomy suggestions, the method further comprising:
transmitting the one or more taxonomy suggestions to an expert for a one-time expert review, and
wherein the first set of labels is generated responsive to the one-time expert review.

4. The method of claim 1, wherein the taxonomy driven classification comprises one or more of algorithms including exclusive n-grams extraction, exclusive collocation extraction, fuzzy string match, or custom named entity recognition.

5. The method of claim 1, further comprising:
performing multi-class and multi-label classification using the trained deep learning model, and
wherein the second set of labels is determined based on the multi-class and multi-label classification.

6. The method of claim 5, wherein performing the multi-class and multi-label classification comprises:
detecting multiple contexts within an utterance of the interaction data; and
detecting an order of the multiple contexts in the interaction data,
wherein the second set of labels is determined based on analyzing the multiple contexts and the order.

7. The method of claim 1, wherein:
automatically performing the taxonomy driven classification is based on one or more unsupervised machine learning (ML) approaches,
training the deep learning model is based on one or more supervised ML approaches, and
obtaining the combined set of labels is based on combining the first set of labels predicted using the one or more unsupervised ML approaches and the second set of labels predicted using the one or more supervised ML approaches.

8. The method of claim 1, further comprising:
configuring and adjusting, based at least in part on a type of interaction data, one or more algorithms used in each of analyzing the interaction data, automatically performing the taxonomy driven classification, or training the deep learning model, and
wherein the configuring and adjusting comprise changing at least one of a number of the one or more algorithms or an order of the one or more algorithms.

9. The method of claim 1, wherein prior to analyzing the interaction data, the method comprises:
selecting and customizing pre-processing operations; and
pre-processing the interaction data using the selected pre-processing operations.

10. A system for handling unlabeled interaction data with contextual understanding, the system comprising:
a processor; and
a memory in communication with the processor and comprising instructions which, when executed by the processor, program the processor to:
receive the interaction data describing agent-consumer interactions associated with a contact center;
analyze the interaction data to identify a plurality of features;
automatically perform taxonomy driven classification on the plurality of features to generate a first set of labels associated with the interaction data;
train a deep learning model using the first set of labels and the interaction data to determine a second set of labels;
intelligently combine the first and second sets of labels to obtain a combined set of labels associated with the interaction data; and
retrain, using the combined set of labels, one or more machine learning models including the deep learning model to enhance contextual understanding of the agent-consumer interactions associated with the contact center.

11. The system of claim 10, wherein to analyze the interaction data, the instructions further program the processor to:
configure and perform at least one of word embeddings, topic modeling, or theme mining;
categorize the interaction data into a list of topics or relevant n-grams; and
identify the plurality of features based on categorizing the interaction data.

12. The system of claim 10, wherein the plurality of features comprises one or more taxonomy suggestions, and the instructions further program the processor to:
transmit the one or more taxonomy suggestions to an expert for a one-time expert review, and
wherein the first set of labels is generated responsive to the one-time expert review.

13. The system of claim 10, wherein the taxonomy driven classification comprises one or more of algorithms including exclusive n-grams extraction, exclusive collocation extraction, fuzzy string match, or custom named entity recognition.

14. The system of claim 10, wherein the instructions further program the processor to:
perform multi-class and multi-label classification using the trained deep learning model, and
wherein the second set of labels is determined based on the multi-class and multi-label classification.

15. The system of claim 14, wherein to perform multi-class and multi-label classification, the instructions further program the processor to:
detect multiple contexts within an utterance of the interaction data; and
detect an order of the multiple contexts in the interaction data,
wherein the second set of labels is determined based on analyzing the multiple contexts and the order.

16. The system of claim 10, wherein:
automatically performing the taxonomy driven classification is based on one or more unsupervised machine learning (ML) approaches,
training the deep learning model is based on one or more supervised ML approaches, and
obtaining the combined set of labels is based on combining the first set of labels predicted using the one or more unsupervised ML approaches and the second set of labels predicted using the one or more supervised ML approaches.

17. The system of claim 16, wherein the instructions further program the processor to:
configure and adjust, based at least in part on a type of interaction data, one or more algorithms used in each of analyzing the interaction data, automatically performing the taxonomy driven classification, or training the deep learning model, and
wherein the configuring and adjusting comprise changing at least one of a number of the one or more algorithms or an order of the one or more algorithms.

18. The system of claim 10, wherein prior to analyzing the interaction data, the instructions further program the processor to:
select and customize pre-processing operations; and
pre-process the interaction data using the selected pre-processing operations.

19. A computer program product for handling unlabeled interaction data with contextual understanding, the computer program product comprising a non-transitory computer readable medium having computer readable program code stored thereon, the computer readable program code configured to:
receive the interaction data describing agent-consumer interactions associated with a contact center;
analyze the interaction data to identify a plurality of features;
automatically perform taxonomy driven classification on the plurality of features to generate a first set of labels associated with the interaction data;
train a deep learning model using the first set of labels and the interaction data to determine a second set of labels;
intelligently combine the first and second sets of labels to obtain a combined set of labels associated with the interaction data; and
retrain, using the combined set of labels, one or more machine learning models including the deep learning model to enhance contextual understanding of the agent-consumer interactions associated with the contact center.

20. The computer program product of claim 19, wherein to analyze the interaction data, the computer readable program code is configured to:
configure and perform at least one of word embeddings, topic modeling, or theme mining;
categorize the interaction data into a list of topics or relevant n-grams; and
identify the plurality of features based on categorizing the interaction data.
